(19) United States
(12) Patent Application Publication
(10) Pub. No.: US 2006/0001980 A1
(43) Pub. Date: Jan. 5, 2006

(54) Optical writing unit and image forming apparatus

(76) Inventor: Masanori Namba, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/169,683

(22) Filed: Jun. 30, 2005

(30) Foreign Application Priority Data
Jun. 30, 2004 (JP) 2004-194635
May 13, 2005 (JP) 2005-140987

(51) Int. Cl. G02B 3/00

(52) U.S. Cl. 359/649

(57) ABSTRACT

An optical writing unit for use in an image forming apparatus, wherein the optical writing unit includes an optical system which generates a light beam to write an electrostatic latent image on an image carrying member of the image forming apparatus, and a casing which encases the optical system. The casing includes an opening portion and a transparent member which externally seals the opening portion and has a top surface higher than a surface of the casing with a predetermined height and an optical writing area through which the light beam emits.

This application claims priority from Japanese patent applications No. 2004-194635 filed on Jun. 30, 2004 and No. 2005-140987 filed on May 13, 2005 in the Japan Patent Office, the entire contents of which are hereby incorporated by reference herein.

### BACKGROUND OF THE INVENTION

1. Field of the Invention

The following disclosure relates generally to an image forming apparatus and an optical writing unit configured to write an electrostatic latent image on an image carrying member with a light beam generated by an optical system.

2. Description of the Invention

Conventionally, an image forming apparatus such as a digital copier, a facsimile, or a printer has employed an optical writing unit to write an electrostatic latent image on a surface of an image carrying member (i.e., photoconductive member) by scanning a light beam, deflected by an optical system such as polygon mirror, on the surface of the image carrying member, wherein the light beam is modulated based on image signals and deflected by an optical system such as polygon mirror, mirrors, and lenses in the optical writing unit.

An increased demand on a miniaturization of the image forming apparatus leads to a variety of arrangements of the optical writing unit in an image forming apparatus. For example, the optical writing unit may be arranged in a horizontal direction with respect to the image carrying member, or may be arranged in a downward direction with respect to the image carrying member. In such an image forming apparatus, deposits such as dust, developing agents or toner may stick on a dust-proof glass provided for a light-beam emitting port of the optical writing unit, and may block a passage of the light beam, thereby resulting in a degradation of image quality.

Particularly, if polymerized toners are used for the image forming apparatus, spattered polymerized toners may more likely adhere and stick to components in the image forming apparatus compared to pulverized toners. In the background art a detachable dust-proof cover over the dust-proof glass has been used for the light-beam emitting port of the optical writing unit so that deposits such as dust do not stick on the dust-proof glass.

If the deposits such as dust stick to the dust-proof glass, the dust-proof cover may be detached in order to clean the dust-proof glass. The dust-proof glass may be cleaned with a cleaning unit having a cleaning pad, which may be provided with the image forming apparatus. However, the above-mentioned background art requires a space around the dust-proof cover and the dust-proof glass to accommodate the detachable dust-proof cover. The required space affects the ability to miniaturize the image forming apparatus.

Furthermore, deposits such as dust and spattered toners, which evade the dust-proof cover, may stick on the dust-proof glass. Consequently, a cleaning operation on the dust-proof glass may be required.

In addition to the above-mentioned situation, because of an increasing demand of high volume printing in a shorter timer, high speed printing, or the like, a heat-effect in image forming apparatus has become an issue for designing a configuration of the image forming apparatus. Specifically, a temperature increase in the image forming apparatus may affect a performance of the optical unit. If such temperature increase affects the optical unit, the image forming apparatus for producing color image may produce a color image print having lower image quality such as color displacement.

In order to reduce the above-mentioned drawback caused by the temperature increase, some image forming apparatuses have been employing a configuration providing a fixing unit in an upper part of the image forming apparatus so that a heat generated in the fixing unit may less likely have an affect on other units such as an optical unit and an image forming unit in the image forming apparatus.

Such a configuration may provide the optical unit under the image forming unit. Consequently, the optical unit conducts scanning to a photoconductive member in a upward-direction. Therefore, a dust-proof glass provided on the optical unit may also come under the image forming unit. Therefore, deposits such as dust and spattered toners may more likely adhere to the dust-proof glass, and may not drop from the dust-proof glass. If polymerized toners having spherical shape adhere to the dust-proof glass, a cleaning operation of the dust-proof glass may become more difficult.

### SUMMARY OF THE INVENTION

Accordingly, the present disclosure relates, accordingly to at least one embodiment of the present invention, to an optical writing unit for use in an image forming apparatus. The optical writing unit includes an optical system which generates a light beam to write an electrostatic latent image on an image carrying member of the image forming apparatus, and a casing which encases the optical system. The casing includes an opening portion and a transparent member. The transparent member externally seals the opening portion and has a top surface higher than a surface of the casing with a predetermined height and an optical writing area through which the light beam emits.

### BRIEF DESCRIPTION OF THE DRAWINGS

A more complete appreciation of the disclosure and many of the attendant advantages and features thereof can readily be obtained and understood from the following detailed description with reference to the accompanying drawings, wherein:

FIG. 1 is a schematic view of an optical writing unit and photoconductive drums of an image forming apparatus according to an example embodiment;

FIG. 2 is a schematic perspective view of an optical writing unit in FIG. 1;

FIG. 3 is a schematic view of an image forming apparatus having an optical writing unit in FIG. 1;

FIG. 4 is a schematic view explaining a relationship of an optical writing unit, an image forming unit, and a transfer belt of an image forming apparatus according to an example embodiment;

FIG. 5 is a partial view of a dust-proof glass provided for an optical writing unit in FIG. 2;

FIG. 6A is a schematic view explaining a relationship of a dust-proof glass of an optical writing unit, a casing of an optical writing unit, and a cleaning member, wherein a width of the cleaning member is larger than a width of the dust-proof glass;

FIG. 6B is a schematic view explaining a relationship of a dust-proof glass of an optical writing unit, a casing of an optical writing unit, and a cleaning member, wherein a width of the cleaning member is smaller than a width of the dust-proof glass;

FIG. 7A is a schematic view explaining a relationship of a cleaning tool, a casing of an optical writing unit, and a dust-proof glass of an optical writing unit of an image forming apparatus according to an example embodiment;

FIG. 7B is a schematic cross-sectional view at the line 7B-7B in FIG. 7A;

FIG. 8 is a schematic view explaining a positional relationship of a dust-proof glass, a casing of an optical writing unit, and a cleaning member;

FIG. 9 is a schematic view explaining a relationship of thickness of a dust-proof glass with respect to a casing of an optical writing unit;

FIG. 10 is another schematic side view explaining a positional relationship of a dust-proof glass, a casing of an optical writing unit, and a cleaning member;

FIG. 11 is another schematic view explaining a relationship of thickness of a dust-proof glass with respect to a casing of an optical writing unit;

FIG. 12 is a schematic view explaining a relationship of another cleaning tool, a casing of an optical writing unit, and a dust-proof glass of an optical writing unit of an image forming apparatus;

FIGS. 13A, 13B, and 13C show a cleaning operation of a dust-proof glass using a cleaning tool having an inflection portion;

FIG. 13D is a schematic cross-sectional view at the line 13D-13D in FIG. 13C;

FIG. 14A is a schematic sectional view of another cleaning tool having an inflection portion; and

FIG. 14B is a schematic sectional view of another cleaning tool having an inflection portion.

### DETAILED DESCRIPTION OF THE EMBODIMENTS

In describing example embodiments illustrated in the drawings, specific terminology is employed for the sake of clarity. However, the disclosure of this present invention is not intended to be limited to the specific terminology so selected and it is to be understood that each specific element includes all technical equivalents that operate in a similar manner.

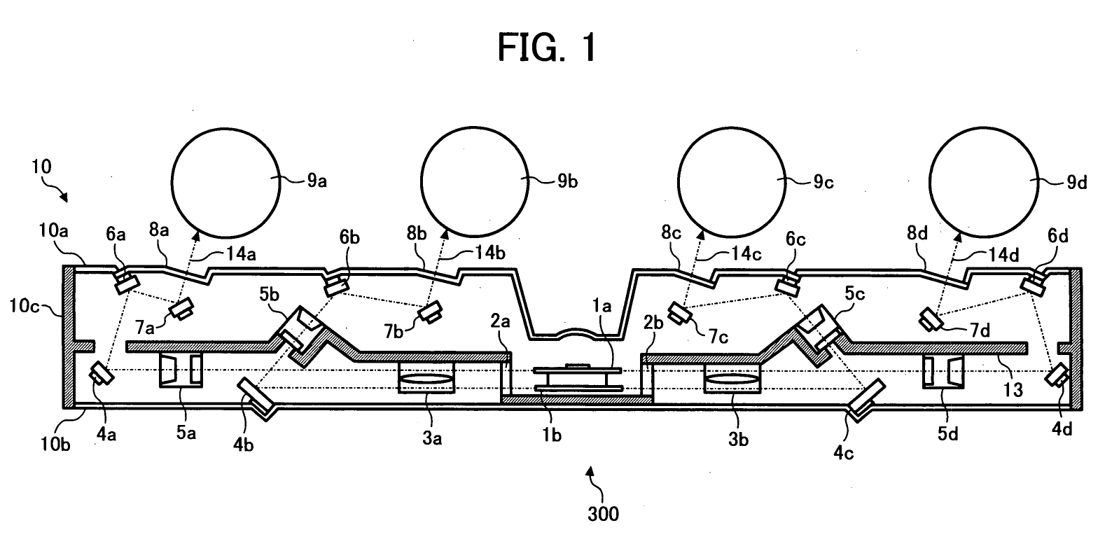

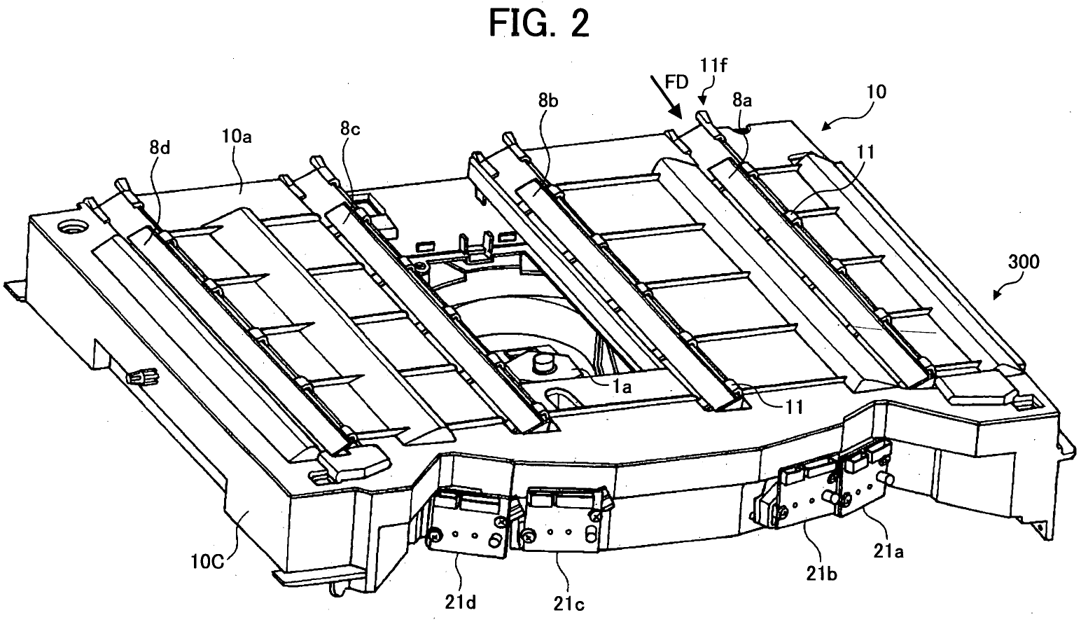

Referring now to the drawings, wherein like reference numerals designate identical or corresponding parts throughout the several views, and more particularly to FIGS. 1 and 2 thereof, an optical writing unit 300 of an image forming apparatus according to an example embodiment of the present invention is described.

The optical writing unit 300 shown in FIG. 1 can be used in an image forming apparatus having a tandem configuration which arranges a plurality of image carrying members (i.e., photoconductive drums 9a, 9b, 9c, and 9d) side by side for producing a full color image.

The optical writing unit 300 can be arranged under the photoconductive drums 9a, 9b, 9c, and 9d as shown in FIG. 1, for example.

Each of the photoconductive drums 9a, 9b, 9c, and 9d forms a yellow image, a magenta image, a cyan image, and a black image, respectively, wherein a positional sequence of photoconductive drums 9a, 9b, 9c, and 9d is changeable.

Although not shown in FIG. 1, each of the photoconductive drums 9a, 9b, 9c, and 9d is surrounded with a plurality of known components used for image forming conducted by an electro-photocopying method.

As shown in FIGS. 1 and 2, the optical writing unit 300 includes light-source units 21a, 21b, 21c, and 21d, polygon mirrors 1a and 1b, f-theta lenses 3a and 3b, focus lenses 5a, 5b, 5c, and 5d, and reflecting mirrors 4a, 4b, 4c, 4d, 6a, 6b, 6c, 6d, 7a, 7b, 7c, and 7d, and a casing 10.

Each of the light-source units 21a, 21b, 21c, and 21d includes a laser diode, for example.

The casing 10 includes an upper wall 10a, a bottom wall 10b, and a side wall 10c.

The polygon mirrors 1a and 1b deflect each of light beams coming from the light-source units 21a, 21b, 21c, and 21d to two directions as shown in FIG. 1.

The f-theta lenses 3a and 3b, and the focus lenses 5a, 5b, 5c, and 5d are provided in symmetrical positions with respect to the polygon mirrors 1a and 1b.

The f-theta lenses 3a and 3b, and the focus lenses 5a, 5b, 5c, and 5d guide light beams deflected by the polygon mirrors 1a and 1b to a surface of each of the photoconductive drums 9a, 9b, 9c, and 9d via the reflecting mirrors 4a, 4b, 4c, 4d, 6a, 6b, 6c, 6d, 7a, 7b, 7c, and 7d as shown in FIG. 1.

As shown in FIG. 1, the casing 10 includes the upper wall 10a, the bottom wall 10b, and the side wall 10c, and contains a support plate 13 therein.

The support plate 13 is provided in a middle of the casing 10 so that the support plate 13 divides an inner space of the casing 10 as shown in FIG. 1.

As shown in FIG. 2, the light-source units 21a, 21b, 21c, and 21d are provided to the side wall 10c.

As shown in FIGS. 1 and 2, the polygon mirrors 1a and 1b are provided to a substantially center position of the support plate 13 (i.e., concaved portion).

As shown in FIG. 1, the f-theta lenses 3a and 3b, focus lenses 5a, 5b, 5c, and 5d, and reflecting mirrors 4a, 4b, 4c, 4d, 6a, 6b, 6c, 6d, 7a, 7b, 7c, and 7d are provided to the upper wall 10a, side wall 10c, bottom wall 10b, and the support plate 13.

Because the casing 10 has the upper wall 10a, the side wall 10c, and the bottom wall 10b, four openings 31a, 31b, 31c, and 31d are provided on the upper wall 10a to cause the light beams to pass therethrough to the photoconductive drums 9a, 9b, 9c, and 9d.

Each of the openings 31a, 31b, 31c, and 31d is sealed by dust-proof glasses 8a, 8b, 8c, and 8d, respectively.

The optical writing unit 300 receives image data (e.g., primary color signals) from an input-unit such as document reader (not shown), personal computer (not shown), word processor (not shown), or facsimile (not shown), in which primary color image data is generated from image information.

Such image data is converted to light-source driving signals, and each of the light-source units 21a, 21b, 21c, and 21d emits a respective light beam based on the light-source driving signals.

The light beams deflect symmetrically with respect to the polygon mirror 1a and 1b. That is, two light beams are deflected in a first direction, and another two light beams are deflected in a second direction, which is symmetrical to the first direction as shown in FIG. 1.

FIG. 1 shows a configuration providing two polygon mirrors (i.e., polygon mirrors 1a and 1b) in a double-decked manner, in which the polygon mirror 1a deflects light beams 14a and 14d for scanning the photoconductive drum 9a and 9d, and the polygon mirror 1b deflects light beams 14b and 14c for scanning the photoconductive drums 9b and 9c.

Although FIG. 1 shows a configuration providing two polygon mirrors (i.e., polygon mirrors 1a and 1b) in a double-decked manner, one polygon mirror having a larger thickness which can deflect four light beams can be used for scanning the photoconductive drums 9a, 9b, 9c, and 9d, for example.

As shown in FIG. 1, the light beams 14a and 14d deflected at the polygon mirror 1a pass through the f-theta lenses 3a and 3b, reflect at the first reflection mirrors 4a and 4d, pass through the focus lenses 5a and 5d, reflect at the second reflection mirrors 6a and 6d, further reflect at the third reflection mirrors 7a and 7d, pass through the dust-proof glass 8a and 8d, and then scan photoconductive drums 9a and 9d, respectively.

As also shown in FIG. 1, the light beams 14b and 14c deflected at the polygon mirrors 1b pass through the f-theta lenses 3a and 3b, reflect at the first reflection mirrors 4b and 4c, pass through the focus lenses 5b and 5c, reflect at the second reflection mirrors 6b and 6c, further reflect at the third reflection mirrors 7b and 7c, pass through the dust-proof glass 8b and 8c, and then scan photoconductive drums 9b and 9c, respectively.

With such a scanning operation, an electrostatic latent image is formed on each surface of the photoconductive drums 9a, 9b, 9c and 9d.

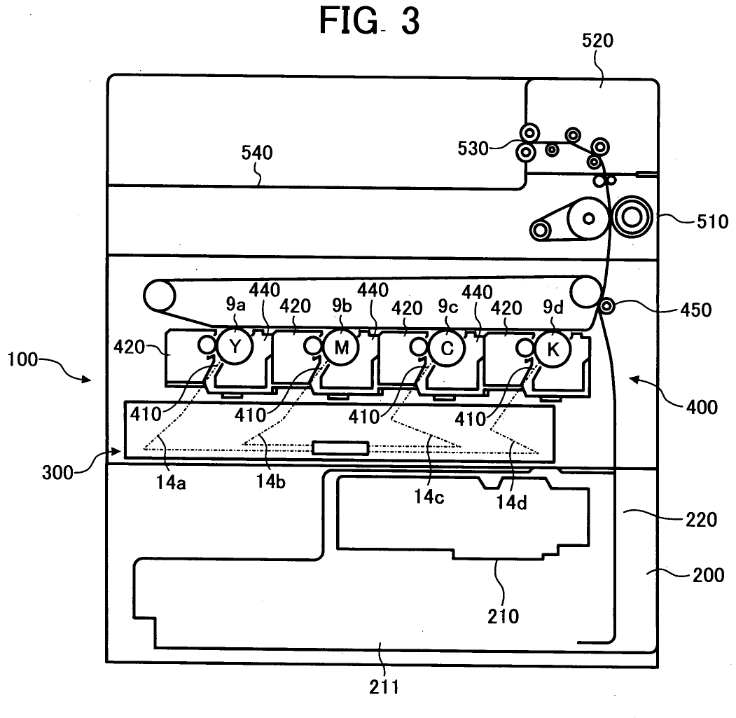

FIG. 3 is a schematic view of image forming apparatus having an optical writing unit shown in FIGS. 1 and 2.

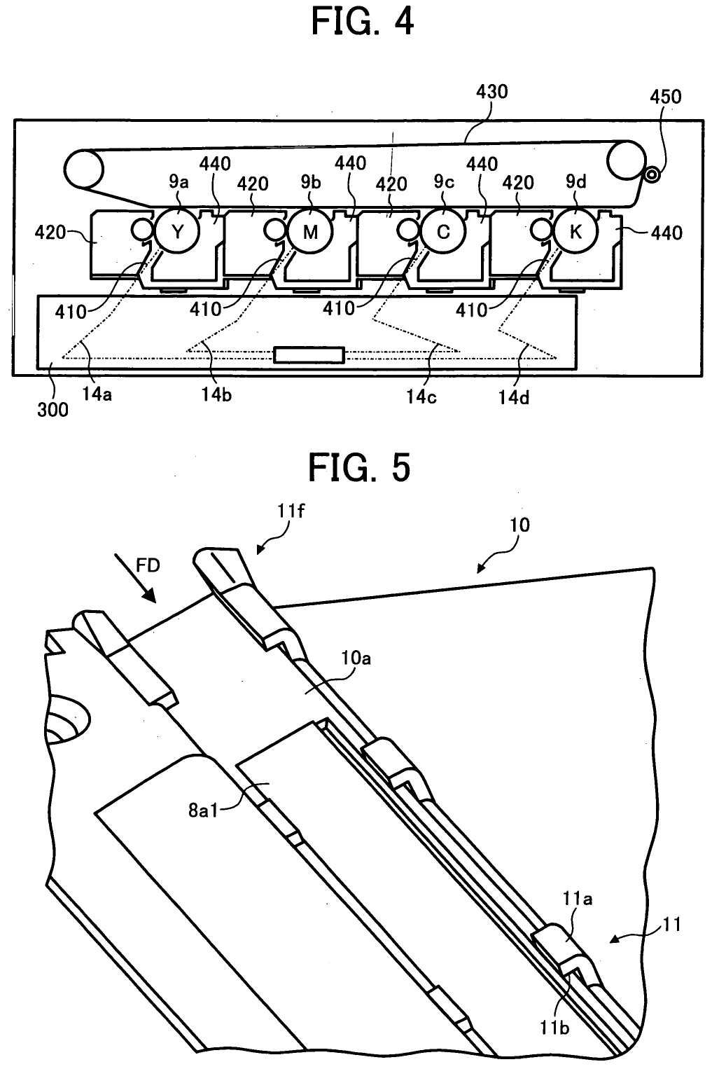

FIG. 4 is a schematic view explaining a relationship of an optical writing unit, an image forming unit, and a transfer belt of an image forming apparatus according to an example embodiment.

As shown in FIG. 3, an image forming apparatus 100 includes a sheet-feed unit 200, the optical writing unit 300, an image forming unit 400, and a fixing unit 510.

Specifically, the sheet-feed unit 200, the optical writing unit 300, the image forming unit 400, and the fixing unit 510 are provided from the bottom portion to the upper-most portion of the image forming apparatus 100 as shown in FIG. 3.

The sheet-feed unit 200 includes sheet cassettes 210 and 211. A sheet is picked up from the sheet cassettes 210 or 211 by a sheet-feed roller (not shown), and transported to the image forming unit 400 through a transport line 220.

In the image forming unit 400, the electrostatic latent image written on each of the photoconductive drums 9a, 9b, 9c, and 9d by the optical writing unit 300 is developed as a toner image and transferred to a sheet.

As shown in FIG. 4, the image forming unit 400 includes the photoconductive drum 9a, 9b, 9c, and 9d, and other components provided around the photoconductive drums 9a, 9b, 9c, and 9d for image forming.

Specifically, the image forming unit 400 includes a charging unit (not shown) having a charger such as charge roller and charge brush, an exposing part 410, a developing unit 420, a intermediate transfer belt 430, a drum-cleaning unit (not shown), a de-charger for the photoconductive drums 9a, 9b, 9c, and 9d.

At the exposing part 410, the light beam emitted from the optical writing unit 300 exposes the photoconductive drums 9a, 9b, 9c, and 9d.

The developing unit 420 is used to develop a yellow image, a magenta image, a cyan image, a black image on each of the photoconductive drums 9a, 9b, 9c, and 9d.

Toner images developed on the photoconductive drums 9a, 9b, 9c, and 9d are transferred to the intermediate transfer belt 430.

The drum-cleaning unit (not shown) removes toners remaining on the photoconductive drums 9a, 9b, 9c, and 9d, and the de-charger de-charges the photoconductive drums 9a, 9b, 9c, and 9d for a subsequent image forming process.

In an example embodiment of the present invention, the charger, the drum-cleaning unit, the de-charger and the photoconductive drum may be integrated as a photoconductive unit 440.

The developing unit 420 and the photoconductive unit 440 are detachably provided in the image forming apparatus 100.

The toner images transferred to the intermediate transfer belt 430 are further transferred to the sheet, transported from the sheet-feed unit 200, at a transfer position 450.

Then the sheet is fed to the fixing unit 510 to fix the toner images on the sheet.

After the fixing, the sheet is ejected to an ejection tray 540 from an ejection port 530 of an ejection unit 520.

In addition, after transferring the toner image to the sheet at the transfer position 450, toners remaining on the intermediate transfer belt 430 are removed by a belt-cleaning unit (not shown) provided in the image forming unit 400.

FIG. 5 is a partial view of the dust-proof glass 8a on the upper wall 10a of the optical writing unit 300.

Although not shown in FIG. 5, the dust-proof glasses 8b, 8c, and 8d are similarly attached on the upper wall 10a of the optical writing unit 300.

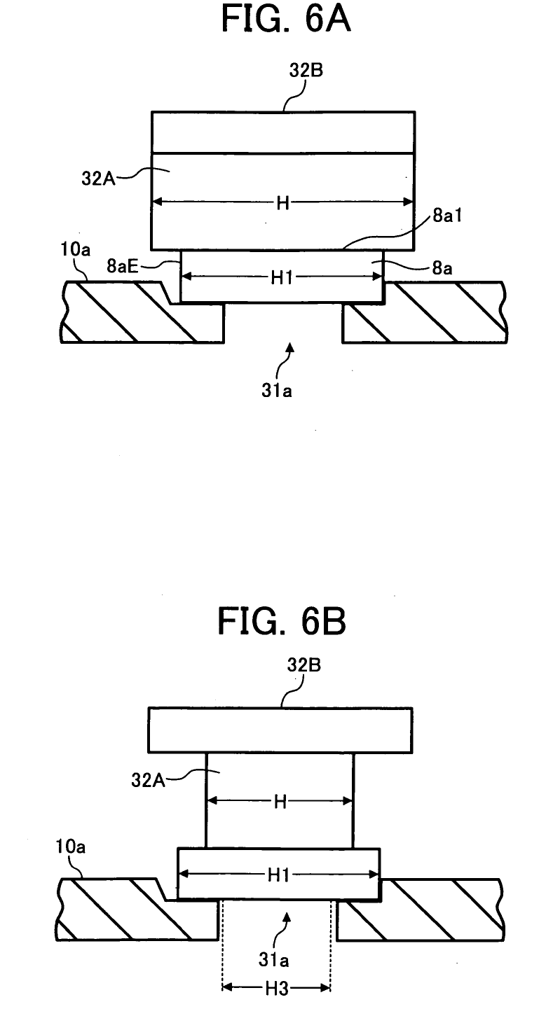

As show in FIG. 6, the dust-proof glass 8a externally seals the opening 31a formed on the upper wall 10a from an outer side of the casing 10, wherein the light beam 14a passes through the opening 31a and the dust-proof glass 8a.

The dust-proof glass 8a is provided over the opening 31a by attaching peripheral portions of the dust-proof glass 8a to an area surrounding the opening 31a.

For example, a double-sided adhesive tape is attached to the peripheral portions of the dust-proof glass 8a at first, and then the peripheral portions of the dust-proof glass 8a is attached to the area surrounding the opening 31a.

As shown in FIG. 6A, a recessed area surrounding the opening 31a is provided on the upper wall 10, and the dust-proof glass 8a is attached to such recessed area.

A depth of the recessed area and a thickness of the dust-proof glass 8a is adjusted so that a top surface 8a1 of the dust-proof glass 8a can protrude from a surface of the upper wall 10a as shown in FIG. 6A.

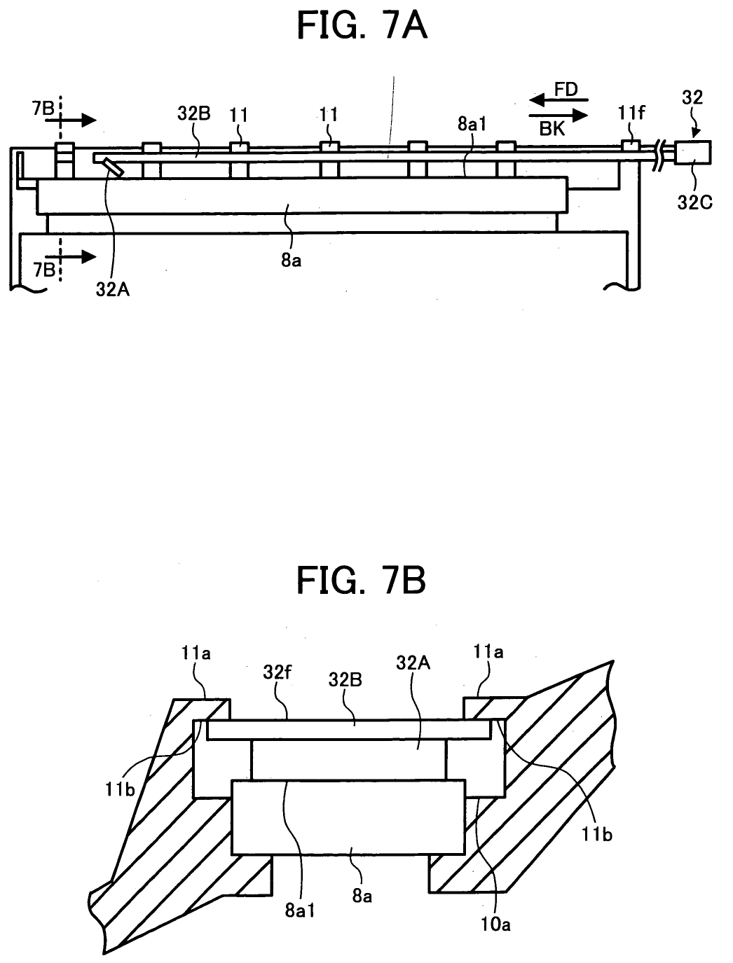

Therefore, a cleaning tool 32 (see FIG. 7A) having a cleaning member 32A can contact the top surface 8a1 of the dust-proof glass 8a without an interference of the upper wall 10a, and the cleaning tool 32 can remove deposits (e.g., toner powders and dust) on the top surface 8a1 of the dust-proof glass 8a without an interference of the upper wall 10a.

As shown in FIG. 7A, the cleaning tool 32 includes a cleaning member 32A, a support member 32B, and a handling part 32C.

As shown in FIG. 7A, the cleaning member 32A is attached to one end portion of the support member 32B having a longer plate shape, and the handling part 32C is attached to other end portion of the support member 32B.

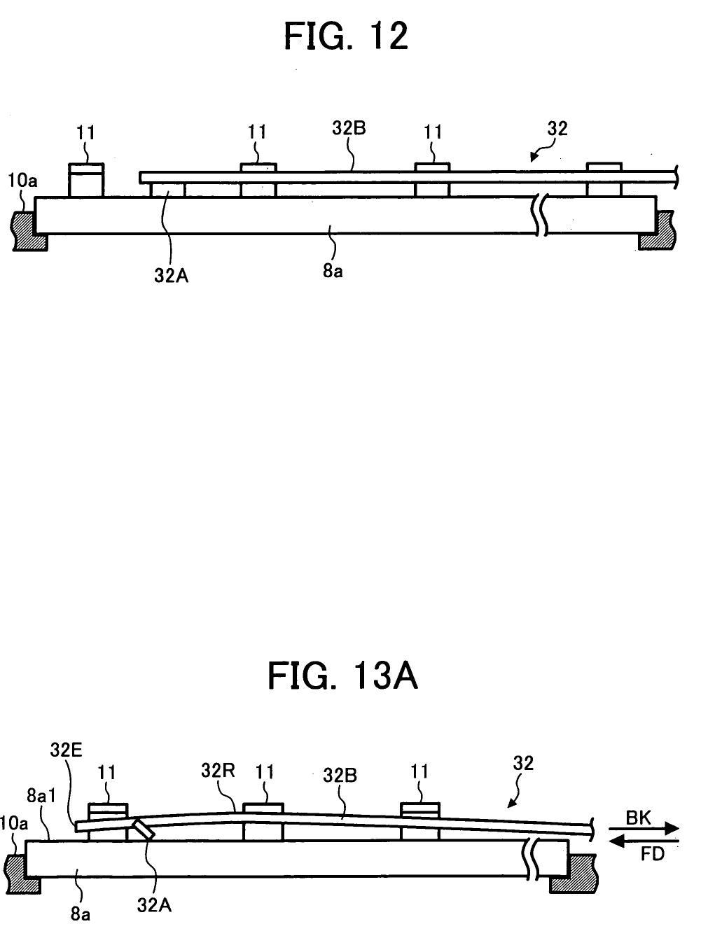

The cleaning member 32A includes a blade type (shown in FIG. 7A), a brush type, felt type, or a sponge type (shown in FIG. 12), for example.

Preferably, the cleaning member 32A employs a blade type formed of a synthetic resin (e.g., polyurethane rubber), which is also used for a photoconductive member and intermediate transfer belt. An effective cleaning operation on the top surface 8a1 can be obtained by cleaning the top surface 8a1 using an edge 32Ae of the cleaning member 32A. Hereinafter, a cleaning operation using the cleaning member 32A having a blade type is explained in detail.

As shown in FIGS. 6A and 6B, a width of the cleaning member 32A is defined as “H,” a width of the dust-proof glass 8a is defined as “H1,” and a width required for passing through a laser beam is defined as “H3.”

As shown in FIG. 6A, “H” can be adjusted to a width which can clean an entire surface of the dust-proof glass 8a. Such conditions can be defined as below from FIG. 6A.
H≧H1

As shown in FIG. 6B, “H” can be adjusted to a width, which can cover an area required for passing through a laser beam on the dust-proof glass 8a.

In this case, “H” can be set as a smaller value than “H1” because the cleaning member 32A can effectively clean the top surface 8a1 with a width of “H3.”

Therefore, “H” can be set as below:
H3≦H≦H1

It is preferable that “H” of the cleaning member 32A is set to the above-range of “H3≦H≦H1” because the edge 8aE of the dust-proof glass 8a does not interfere with the cleaning member 32A when cleaning the dust-proof glass 8a if “H” of the cleaning member 32A is set to the above-range of“H3≦H≦H1”. Consequently, the cleaning member 32A will likely not receive damage from the edge 8aE of the dust-proof glass 8a.

As show in FIG. 5 and FIG. 7A, a plurality of guide members 11 are provided along a longitudinal direction and a side area of the dust-proof glass 8a on the upper wall 10a. The plurality of guide members 11 are provided on the upper wall 10a with an equal interval between adjacent guide members 11, for example, to guide the cleaning tool 32.

As shown in FIG. 5, each of the guide members 11 includes a pair of guide pieces.

An edge portion 11a of the guide piece is extended over the dust-proof glass 8a while the edge portion 11a is parallel to the top surface 8a1 of the dust-proof glass 8a.

FIG. 7B show a cross-sectional view at the line 7B-7B in FIG. 7A.

As shown in FIG. 7B, the edge portion 11a of the guide piece includes a face 11b, which faces the dust-proof glass 8a.

As shown in FIG. 7B, the face 11b of the edge portion 11a contacts a face 32f of the support member 32B of the cleaning tool 32.

The guide members 11 hold the support member 32B while the cleaning tool 32 conducts a cleaning operation, and guide the support member 32B when moving the cleaning tool 32 in a longitudinal direction of the dust-proof glass 8a.

When cleaning the dust-proof glass 8a, the cleaning tool 32 is inserted from a guide member 11f, which is provided to a front side of the optical writing unit 300 as shown in FIG. 5.

The cleaning member 32A of the cleaning tool 32 is inserted from the guide member 11f in the arrow direction “FD” as shown in FIG. 7A.

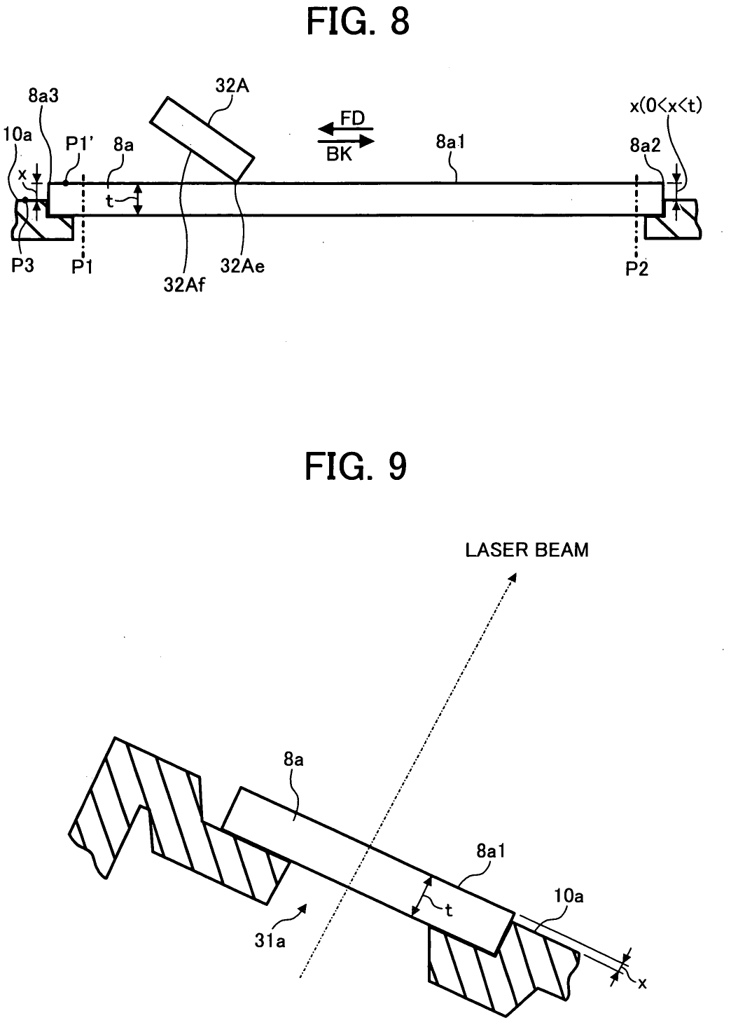

At first, as shown in FIG. 8, the cleaning member 32A is moved to a point P1′, which is located between an edge 8a3 of the dust-proof glass 8a and a point P1. The point P1 and a point P2 shown in FIG. 8 define an optical writing area, through which the light beam emits. Then, the cleaning member 32A is moved from the point P1′ in an arrow direction “BK” to remove deposits (e.g., toner powders and dust) on the top surface 8a1 of the dust-proof glass 8a.

When inserting the cleaning tool 32 from the arrow direction “FD”, the cleaning member 32A goes over the edge 8a2 of the dust-proof glass 8a. At this time, a face 32Af of the cleaning member 32A contacts the surface of the dust-proof glass 8a as shown in FIG. 8, and deforms elastically. Consequently the cleaning member 32A may perform an effective deposit-removing operation. However, because of such elasticity of the cleaning member 32A, the cleaning member 32A receives little damage when the cleaning member 32A goes over the edge 8a2 of the dust-proof glass 8a.

When the cleaning member 32A is moved in the arrow direction “BK,” an edge 32Ae of the cleaning member 32A functions as a scraper. The edge 32Ae of the cleaning member 32A contacts the top surface 8a1 of the dust-proof glass 8a, and removes deposits (e.g., toner powders and dust) on the top surface 8a1 of the dust-proof glass 8a so that an effective cleaning operation can be favorably conducted. Consequently, the arrow direction “BK” becomes a direction for the cleaning operation on the top surface 8a1 of the dust-proof glass 8a.

When moving the cleaning member 32A in the arrow direction “FD,” the guide member 11f may function as a positional regulator which regulates a moving range of the cleaning tool 32 so that the cleaning member 32A does not reach the upper wall 10a by passing over the edge 8a3 of the dust-proof glass 8a shown in FIG. 8. With such regulation, the edge 32Ae of the cleaning member 32A can be moved from the point P1′ in the arrow direction “BK.” Consequently, the edge 32Ae of the cleaning member 32A does not run on the edge 8a3 of the dust-proof glass 8a, and the edge 32Ae of the cleaning member 32A does not receive damages from the edge 8a3 of the dust-proof glass 8a. Accordingly, the cleaning member 32A can be used in a stable condition over a longer period.

The above-mentioned operations of the cleaning tool 32 can be conducted by moving the handling part 32C of the cleaning tool 32 in the directions “FD” and “BK.” During the insertion of the cleaning tool 32 in the direction “FD,” the cleaning member 32A may remove deposits (e.g., toner powders and dust) adhered to the top surface 8a1 of the dust-proof glass 8a.

These deposits (e.g., toner powders and dust) are pushed over the point P1 shown in FIG. 8, and may be pushed over on the upper wall 10a. Consequently, such deposits may not remain on the optical writing area defined by the point P1 and P2 shown in FIG. 8. Accordingly, a cleaning may be conducted during the insertion of the cleaning tool 32 in the direction “FD.”

Furthermore, the top surface 8a1 of the dust-proof glass 8a can be flush with a surface of the upper wall 10a, or the top surface 8a1 of the dust-proof glass 8a can be below the surface of the upper wall 10a. However, if the top surface 8a1 of the dust-proof glass 8a is below the surface of the upper wall 10a, the cleaning member 32A may not securely contact the top surface 8a1 of the dust-proof glass 8a.

For example, the cleaning member 32A may contact at one area on the top surface 8a1 of the dust-proof glass 8a, but may not contact at another area on the top surface 8a1 of the dust-proof glass 8a. If such an unstable contacting condition occurs, a cleaning operation by the cleaning member 32A may reduce its cleaning effectiveness.

In view of such background, in an example embodiment of the present invention, the top surface 8a1 of the dust-proof glass 8a protrudes from the surface of the upper wall 10a with a predetermined protruding height “X” as shown in FIGS. 8 and 9. With such arrangement, the edge 32Ae of the cleaning member 32A contacts closely with the top surface 8a1 of the dust-proof glass 8. Consequently, the cleaning member 32A can effectively conduct a cleaning operation on the top surface 8a1 of the dust-proof glass 8a.

However, if the predetermined protruding height “X” becomes too large, the top surface 8a1 of the dust-proof glass 8a protrudes more and more from the surface of the upper wall 10a. In such a case, the guide members 11 need to protrude more and more from the surface of the upper wall 10a, and such guide members 11 may interfere with other components. Therefore, in order to prevent interferences between components, the predetermined protruding height “X” of the dust-proof glass 8a is defined as below and as shown in FIG. 9.
0<X<t
wherein “t” is a thickness of the dust-proof glass 8a.

Specifically, the thickness “t” of the dust-proof glass 8a is preferably set from 1 to 3 mm, and more preferably about 2 mm, and the predetermined protruding height “X” of the dust-proof glass 8a is preferably set to about 0.5 mm, for example.

Assume a case that a point P3 is set to a outer side of the edge 8a3 of the dust-proof glass 8a as shown in FIG. 8 and the cleaning member 32A is moved in the arrow direction “BK” from the point P3. In this case, the edge 32Ae of the cleaning member 32A contacts the edge 8a3 of the dust-proof glass 8a when the cleaning member 32A is moved in the arrow direction “BK” from the point P3. Consequently, the edge 32Ae of the cleaning member 32A may be damaged at the edge 8a3 of the dust-proof glass 8a.

In order to prevent such a drawback, the surface of the upper wall 10a having the point P3 can be made flush with the top surface 8a1 of the dust-proof glass 8a or can be protruded from the top surface 8a1 of the dust-proof glass 8a.

Therefore, as shown in FIG. 10, the predetermined protruding height “X” of the dust-proof glass 8a and the surface of the upper wall 10a having the point P3 is set to a following relationship at one side of the dust-proof glass 8a which faces the surface of the upper wall 10a having the point P3.
X≦0

Under a configuration shown in FIG. 10, when the cleaning member 32A is moved on the top surface 8a1 of the dust-proof glass 8a in the arrow direction “FD” by passing over the edge 8a2 of the dust-proof glass 8a, the cleaning member 32A deforms elastically and contacts the edge 8a2 of the dust-proof glass 8a with the face 32Af of the cleaning member 32A. Consequently, the cleaning member 32A receives little damage when passing over the edge 8a2 of the dust-proof glass 8a.

In addition, under a configuration shown in FIG. 10 and the condition of “X≦0” at one side of the dust-proof glass 8a which faces the surface of the upper wall 10a having the point P3, when the cleaning member 32A is moved from the point P3 in the arrow direction “BK” for cleaning the top surface 8a1 of the dust-proof glass 8a, the edge 32Ae of the cleaning member 32A does not contact the edge 8a3 of the dust-proof glass 8a. Consequently, the edge 32Ae of the cleaning member 32A does not receive damage from the edge 8a3 of the dust-proof glass 8a.

Furthermore, the cleaning member 32A can remove deposits (e.g., toner powders and dust) from the top surface 8a1 of the dust-proof glass 8a effectively because the top surface 8a1 of the dust-proof glass 8a protrudes from the surface of the upper wall 10a in a cleaning area of the top surface 8a1 of the dust-proof glass 8a.

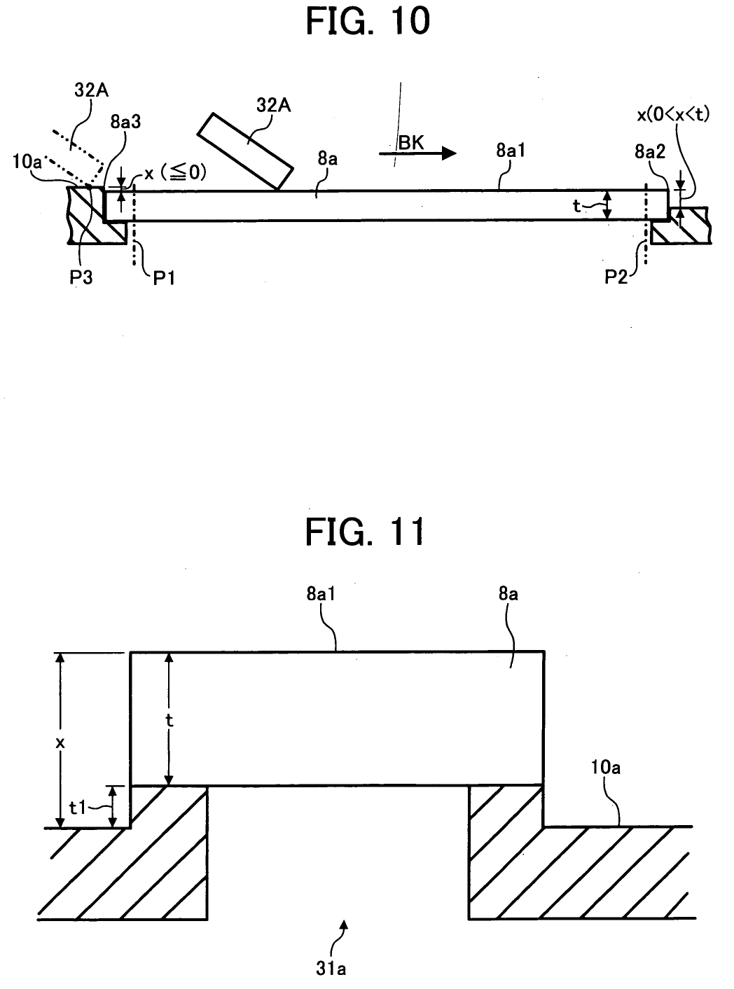

FIG. 11 shows another case where the dust-proof glass 8a is provided on the upper wall 10a without providing the above-mentioned recessed area, which is different from a configuration having the recessed area shown in FIG. 9.

As shown in FIG. 11, the dust-proof glass 8a having a predetermined thickness of “t” can be provided on the casing 10 by providing an attachment area having a predetermined height of “t1” from the surface of the upper wall 10a of the casing 10. Consequently, the top surface of the dust-proof glass 8a protrudes from the surface of the upper wall 10a with a protruding amount of “X” as shown in FIG. 11.

Although not shown in FIG. 11, the dust-proof glass 8a may be provided on the attachment area with an adhesive material such as double-sided tape. In such a case, the adhesive material such as the double-sided tape exists between the dust-proof glass 8a and the attachment area.

Because the attachment area has a predetermined height as shown in FIG. 11, a relationship “t1>0” may be set. In the above-described example embodiment, the top surface 8a1 of the dust-proof glass 8a protrudes from the surface of the upper wall 10a of the casing 10. Therefore, deposits (e.g., toner powders and dust) removed by the cleaning tool 32 will not remain on the top surface 8a1 of the dust-proof glass 8a, and an effective cleaning can be conducted. Such an effective cleaning operation can be conducted for the optical writing unit 300 of an example embodiment of the present invention, in which the dust-proof glass 8a faces the image forming unit 400 in an upward-direction in the image forming apparatus.

As above-described, the top surface 8a1 of the dust-proof glass 8a protrudes from the surface of the upper wall 10a with the predetermined protruding height “X” having the following relationship.
0<X<t
wherein “t” is a thickness of the dust-proof glass 8a. With such a condition, a displacement of the dust-proof glass 8a can be prevented during a cleaning operation conducted by the cleaning member 32A on the dust-proof glass 8a because the dust-proof glass 8a can be attached in the recessed area.

In the above-described example embodiment, explanations are given only to the dust-proof glass 8a. However, other dust-proof glasses 8b, 8c, and 8d can take a similar configuration as the dust-proof glass 8a. Therefore, the above-described explanations can be also applied to the dust-proof glasses 8b, 8c, and 8d.

When the cleaning tool 32 is not-in-use, the cleaning tool 32 can be held in a holder (not shown) provided in the image forming apparatus 100 shown in FIG. 3. Specifically, such a holder (not shown) can be provided inside a body of the image forming apparatus 100. For example, the holder can be provided in an inside-panel (e.g., front panel or side panel) of the image forming apparatus 100 so that the holder can hold the cleaning tool 32 when not-in-use. When a user determines that a cleaning operation is needed on the dust-proof glasses 8a, 8b, 8c, and 8d, the user can detach the cleaning tool 32 from the holder and conduct the cleaning operation on the dust-proof glasses 8a, 8b, 8c, and 8d with the cleaning tool 32.

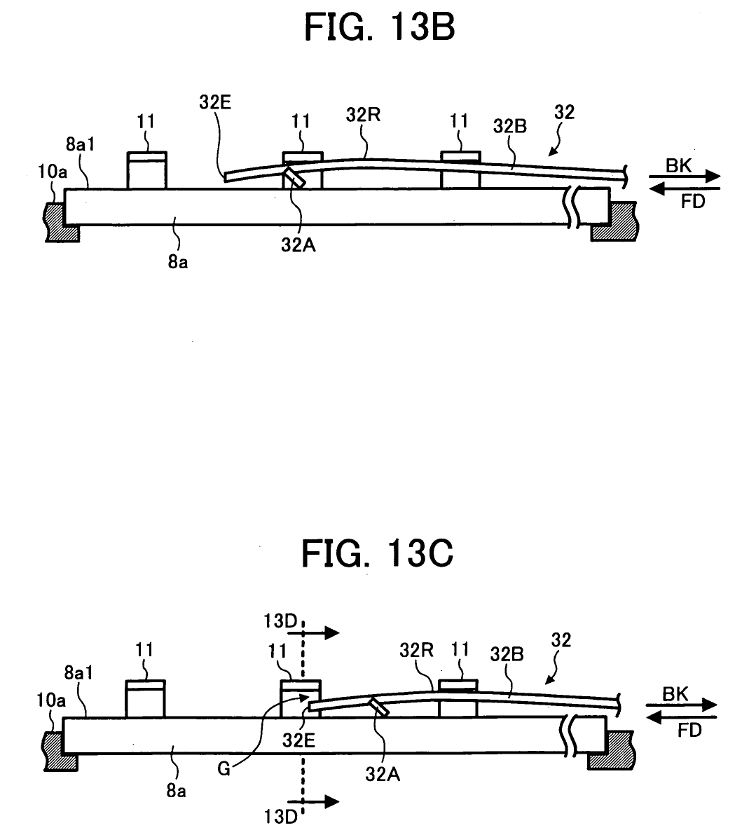

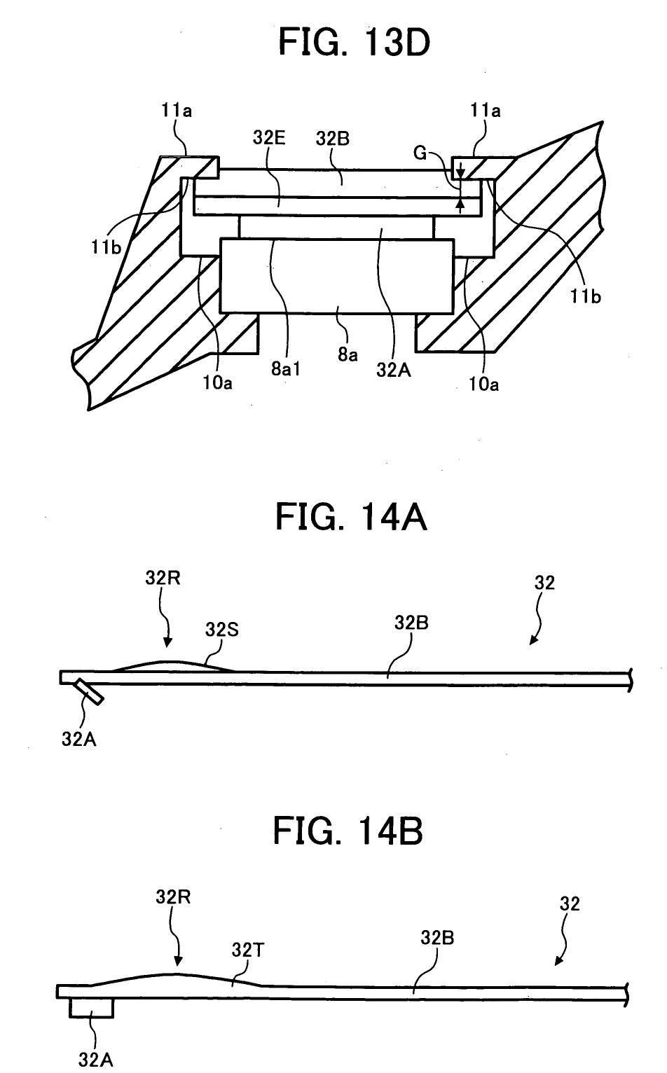

FIGS. 13A, 13B, and 13C show a cleaning operation of a dust-proof glass using another cleaning tool 32 according to another example embodiment.

FIG. 13D is a schematic cross-sectional view at the line 13D-13D in FIG. 13C.

Because this example embodiment employs a similar configuration as in the above-described example embodiment except for the cleaning tool 32, similar components are identified with the same reference characters and descriptions regarding their functionality are omitted from the following description.

The cleaning tool 32 according to the example embodiment shown in FIGS. 13A to 13C includes the cleaning member 32A of a blade type, and the support member 32B which has an inflection portion 32R on a part of the support member 32B. The inflection portion 32R can be provided at a position which is closer to the cleaning 32A as shown in FIG. 13A to 13C. The inflection portion 32R has a convex-shape with respect to the dust-proof glass 8a. The inflection portion 32R can prevent warping of the support member 32B in an upward-direction with an elasticity of the support member 32B.

If the cleaning tool 32 includes the support member 32B having no inflection portion 32R, the face 32f of the support member 32B may contact the guide members 11 entirely. Under such a contacting condition, whenever an edge 32E of the support member 32B passes through the guide members 11 while cleaning the dust-proof glass 8a, the edge 32E of the support member 32B may warp in an upward direction due to an elasticity of the support member 32B. If such warping occurs at the edge 32E of the support member 32B, a contact pressure of the cleaning member 32A to the top surface 8a1 of the dust-proof glass 8a may not be maintained at a stable level, and such a condition may lead to a degradation of cleaning effectiveness.

In another example embodiment, the support member 32B includes the inflection portion 32R provided thereon as shown in FIGS. 13A, 13B, 13C, 13D, and the cleaning tool 32 is moved in the arrow direction “BK” for cleaning the dust-proof glass 8a.

In such a configuration, a position of the inflection portion 32R on the support member 32B, a gradient of inflection, and an interval of adjacent guide members 11 are determined so that at least one of the guide members 11 contacts the face 32f of the support member 32B as shown in FIG. 13A, for example. Moreover, at least one of the guide members 11 may be located at a position nearest to the cleaning member 32A in the direction of “BK,” for example.

FIG. 13D is a schematic cross-sectional view at the line 13D-13D in FIG. 13C. As shown in FIG. 13D, a gap “G” exists between the edge 32E of the support member 32B and the plurality of guide members 11. Consequently, the edge 32E of the support member 32B is contact free with respect to the plurality of guide members 11.

In a configuration shown in FIGS. 13A to 13D, at least one of the guide members 11 applies a holding action to the support member 32B. Consequently, the warping of the edge 32E of the support member 32B can be suppressed. Furthermore, when the support member 32B includes the inflection portion 32R and the edge 32E which does not contact the guide members 11 due to the gap “G”, the cleaning tool 32 can be inserted in the guide members 11 without an interference between the edge 32E and the guide members 11, which is favorable from the viewpoint of the operation of the cleaning tool 32. Furthermore, a contact pressure of the cleaning member 32A to the top surface 8a1 of the dust-proof glass 8a can be adjusted by setting a gradient of inflection of the inflection portion 32R.

FIGS. 14A and 14B show modified support members 32B. FIG. 14A show a modified support member 32B having an inflection portion 32R formed of flat spring 32S, and FIG. 14B show another modified support member 32B having inflection portion 32R formed of a convex-portion 32T which is integrated to the support member 32B.

FIG. 14B shows a cleaning tool including a cleaning member 32A formed of brush, felt, or sponge instead of the blade. Although the cleaning tool 32 shown in FIG. 14A employs a blade type for the cleaning member 32A, other types such as brush, felt, or sponge can be used for the cleaning member 32A. Similarly, although the cleaning tool 32 shown in FIG. 14B employs a brush type, felt type, or sponge type for the cleaning member 32A, a blade type can be used for the cleaning member 32A.

The flat spring 32S shown in FIG. 14A has a gradient of inflection, which is similar to that of the inflection portion 32R shown in FIGS. 13A, 13B, and 13C. With such a gradient of inflection, the support member 32B shown in FIG. 14A can attain a similar function of the support member 32B shown in FIGS. 13A, 13B, and 13C.

Similar to FIG. 14A, FIG. 14B shows another support member 32B having the convex-portion 32T of arc-shape. Whenever the convex-portion 32T passes through the guide members 11, a predetermined contact pressure is applied to the cleaning member 32A to conduct an effective cleaning on the dust-proof glass 8a.

Numerous additional modifications and variations are possible in light of the above teachings. It is therefore to be understood that within the scope of the appended claims, the disclosure of the present invention may be practiced otherwise than as specifically described herein.

1. An optical writing unit for use in an image forming apparatus, the optical writing unit comprising:
an optical system configured to generate a light beam to write an electrostatic latent image on an image carrying member of the image forming apparatus; and
a casing configured to encase the optical system, comprising,
an opening portion, and
a transparent member configured to externally seal the opening portion, and including a top surface higher than a surface of the casing with a predetermined height and an optical writing area through which the light beam emits.

2. The optical writing unit according to claim 1, wherein the top surface of the transparent member faces the image carrying member in an upward-direction.

3. The optical writing unit according to claim 1, further comprising a cleaning tool configured to clean off the top surface of the transparent member, wherein the cleaning tool includes a cleaning member, a support member, and a handling part.

4. The optical writing unit according to claim 3, wherein the casing further comprises a plurality of guide members which are configured to guide the cleaning tool during a cleaning operation.

5. The optical writing unit according to claim 3, wherein the support member includes first and second end portions opposite each other, and the first end portion is attached to the cleaning member and the second end portion is attached to the handling part.

6. The optical writing unit according to claim 4, wherein the cleaning tool is configured to remove a deposit adhered on the top surface of the transparent member with the cleaning member which is contactingly moved on the top surface of the transparent member using the plurality of guide members for guidance.

7. The optical writing unit according to claim 6, wherein the cleaning member includes a blade having an edge portion configured to contact the top surface of the transparent member to remove the deposit adhered to the top surface of the transparent member.

8. The optical writing unit according to claim 5, wherein the support member includes an inflection portion between the first and second end portions of the support member.

9. The optical writing unit according to claim 8, wherein the inflection portion is situated at a highest point along the support member in comparison with heights of the first and second end portions of the support member relative to the top surface of the transparent member.

10. The optical writing unit according to claim 8, wherein the inflection portion is integrally formed on the support member with an arc shape.

11. The optical writing unit according to claim 8, wherein the inflection portion is formed by a flat spring.

12. The optical writing unit according to claim 8, wherein the support member includes a portion which contacts at least one of the plurality of guide members while the first end portion of the support member is contact free with respect to the plurality of guide members when the cleaning tool conducts the cleaning operation.

13. The optical writing unit according to claim 1, wherein (a) the opening portion is surroundingly provided with a recessed area having a predetermined depth from the surface of the casing to receive the transparent member to seal the opening portion, and (b) a height of the transparent member and a height of the surface of the casing satisfy a relationship 0<X<t, wherein X represents a predetermined height of the top surface of the transparent member from the surface of the casing, and t represents a thickness of the transparent member.

14. The optical writing unit according to claim 13, wherein the casing further comprises a position regulator configured to regulate a position of a cleaning tool including a cleaning member, a support member, and a handling part to place the cleaning member at a start point of a cleaning operation by the cleaning tool.

15. The optical writing unit according to claim 14, wherein the position regulator regulates the start point of the cleaning operation between a rear side of the transparent member, from which the cleaning tool starts the cleaning operation, and an end of the optical writing area, which is closest to the rear side of the transparent member.

16. The optical writing unit according to claim 1, wherein the opening portion is surroundingly provided with an attachment area having a predetermined height from the surface of the casing to receive the transparent member to seal the opening portion.

17. The optical writing unit according to claim 16, wherein the casing further comprises a position regulator configured to regulate a position of the cleaning tool including a cleaning member, a support member, and a handling part, to place the cleaning member at a start point of a cleaning operation by the cleaning tool.

18. The optical writing unit according to claim 17, wherein the position regulator regulates the start point of the cleaning operation between a rear side of the transparent member, from which the cleaning tool starts the cleaning operation, and an end of the optical writing area, which is closest to the rear side of the transparent member.

19. The optical writing unit according to claim 1, wherein (a) the transparent member includes a front side from which a cleaning tool including a cleaning member, a support member, and a handling part enters the top surface of the transparent member, and a rear side from which the cleaning tool starts a cleaning operation, and (b) a height of the surface of the casing which faces the rear side of the transparent member and a height of the top surface of the transparent member at the rear side satisfy a relationship X≦0, wherein X represents a predetermined height of the top surface of the transparent member measured from the surface of the casing at the rear side of the transparent member.

20. The optical writing unit according to claim 3, wherein (a) a width of the cleaning member is smaller than a width of the transparent member, and larger than a width of the opening portion, and (b) each of the width of the cleaning member, the transparent member, and the opening portion is perpendicular to a longitudinal direction of the transparent member.

21. An optical writing unit for use in an image forming apparatus, the optical writing unit comprising:
means for generating a light beam to write an electrostatic latent image on an image carrying member of the image forming apparatus; and
means for encasing the means for generating, comprising,
an opening portion, and
a transparent member configured to externally seal the opening portion and including a top surface higher than a surface of the casing with a predetermined height and an optical writing area through which the light beam emits.

22. A method of manufacturing an optical writing unit for use in an image forming apparatus, the method comprising the steps of:
making an opening portion in a surface of a casing of the optical writing unit;
forming an area which surrounds the opening portion; and
mounting a transparent member having a predetermined thickness on the area to seal the opening portion, the transparent member including a top surface higher than the surface of the casing with a predetermined height.

23. The method according to claim 22, wherein the area includes a recessed area having a predetermined depth from the surface of the casing.

24. The method according to claim 22, wherein the area further includes an attachment area having a predetermined height from the surface of the casing.

25. An image forming apparatus, comprising:
an image forming unit including an image carrying member and a developing unit configured to develop an electrostatic latent image as a toner image; and
an optical writing unit, comprising,
an optical system configured to generate a light beam to write an electrostatic latent image on an image carrying member of the image forming apparatus, and
a casing configured to encase the optical system, comprising,
an opening portion, and
a transparent member configured to externally seal the opening portion, and including a top surface higher than a surface of the casing with a predetermined height and an optical writing area through which the light emits.

26. The image forming apparatus according to claim 25, wherein the optical writing unit is provided under the image forming unit.

27. The image forming apparatus according to claim 25, wherein the opening portion is surroundingly provided with a recessed area having a predetermined depth from the surface of the casing to receive the transparent member to seal the opening portion.

28. The image forming apparatus according to claim 25, wherein the opening portion is surroundingly provided with an attachment area having a predetermined height from the surface of the casing to receive the transparent member to seal the opening portion.
